(19) United States
(12) Patent Application Publication
(10) Pub. No.: US 2026/0360977 A1
(43) Pub. Date: Nov. 12, 2026

(54) MULTI-BAND ANTENNA AND COMMUNICATION NODE INCLUDING THE SAME

(71) Applicant: Electronics and Telecommunications Research Institute, Daejeon (KR)

(72) Inventor: Hakmin LEE, Daejeon (KR)

(21) Appl. No.: 19/647,664

(22) Filed: Apr. 14, 2026

(30) Foreign Application Priority Data
May 8, 2025 (KR) 10-2025-0059791

(51) Int. Cl. H01Q 5/30; H01Q 5/20; H01Q 9/04; H01Q 21/06

(52) U.S. Cl. CPC H01Q 5/30; H01Q 5/20; H01Q 9/0421; H01Q 21/065

(57) ABSTRACT

A multi-band antenna capable of processing multi-band signals in a non-terrestrial network is disclosed. The multi-band antenna may include at least one antenna element disposed on one surface of a substrate. The at least one antenna element may include a first patch, a first port disposed at a first side of the first patch to transmit a signal of a first frequency band to the first patch, a second port disposed at a second side of the first patch perpendicular to the first side of the first patch to transmit a signal of a second frequency band to the first patch, and at least one shorting pin disposed at a position symmetrical to the second port with respect to a y-axis on the first patch.

### CROSS-REFERENCE TO RELATED APPLICATIONS

This application claims priority to Korean Patent Applications No. 10-2025-0059791, filed on May 8, 2025, with the Korean Intellectual Property Office (KIPO), the entire contents of which are hereby incorporated by reference.

### BACKGROUND

### 1. Technical Field

The present disclosure relates to an antenna of a non-terrestrial network, and more particularly, to a multi-band antenna capable of processing signals of multiple frequency bands by configuring dual ports having different feeding schemes in a satellite-based non-terrestrial network.

### 2. Related Art

Communication networks may be classified into a terrestrial network and a non-terrestrial network. A non-terrestrial network may be referred to as a NTN (non-terrestrial network). In a terrestrial network, a communication service for a terminal may be provided by a base station located on the ground. In a non-terrestrial network, a communication service for a terminal may be provided by a base station located in a non-terrestrial region (for example, a satellite, a UAV (unmanned aerial vehicle), a drone, etc.). Communication in a terrestrial network and a non-terrestrial network may be performed based on NR (New Radio) communication technology.

Among non-terrestrial networks, a non-terrestrial network based on a plurality of low earth orbit (LEO) satellites located in a low earth orbit of the Earth may provide low latency and stable connectivity. A non-terrestrial network based on low earth orbit satellites may communicate with ground terminals by using multiple frequency bands in order to provide services such as high-speed large-capacity data transmission, real-time streaming, or voice/video calls. For example, a low earth orbit satellite may perform large-capacity traffic processing or high-definition video transmission through communication using a K band (for example, 10-18 GHz). In addition, a low earth orbit satellite may increase a data transmission rate or a data transmission bandwidth through communication using a Ka band (for example, 18-40 GHz).

As described above, a non-terrestrial network based on low earth orbit satellites requires operation of multi-band communication in order to improve communication reliability or data transmission efficiency in various communication environments. Accordingly, in a non-terrestrial network, a ground terminal may include a multi-band antenna capable of transmitting and receiving signals for multi-band communication with a low earth orbit satellite.

A conventional multi-band antenna has been designed as stacked patches or a multilayer structure. However, it has been difficult to secure transmission and reception performance due to problems such as manufacturing limitations caused by an air gap design or increased design complexity or mutual interference between frequency bands caused by difficulty in arranging multiple ports. Accordingly, development of a multi-band antenna technology capable of supporting multiple frequency bands while suppressing mutual interference through a multi-port structure is required.

### SUMMARY

The present disclosure for resolving the above-described problems is directed to providing a multi-band antenna capable of processing multi-band signals in a non-terrestrial network and a communication node including the same.

According to exemplary embodiments of the present disclosure, a multi-band antenna may include at least one antenna element disposed on one surface of a substrate. The at least one antenna element may include a first patch; a first port disposed at a first side of the first patch to transmit a signal of a first frequency band to the first patch; a second port disposed at a second side of the first patch perpendicular to the first side of the first patch to transmit a signal of a second frequency band to the first patch; and at least one shorting pin disposed at a position symmetrical to the second port with respect to a y-axis on the first patch.

The multi-band antenna may further include a ground substrate bonded to another surface of the first substrate, and the at least one shorting pin may connect the first patch and the ground substrate.

The at least one shorting pin may include a first shorting pin and a second shorting pin, and the at least one antenna element may adjust an input impedance of the second port by adjusting a spacing between the first shorting pin and the second shorting pin.

The at least one antenna element may adjust an input impedance of the second port by adjusting a distance between the first port and the at least one shorting pin.

The at least one antenna element may further include a coupling slot formed along an outer circumferential surface of the first port, and the first port may transmit the signal of the first frequency band to the first patch through the coupling slot.

The at least one antenna element may further include a second patch disposed adjacent to the first side of the first patch; and a third shorting pin disposed adjacent to a side of the second patch.

The at least one antenna element may adjust isolation between the first port and the second port by adjusting a distance between the side of the second patch and the third shorting pin.

The first frequency band may be a K band, and the second frequency band may be a Ka band. In addition, each of the first frequency band and the second frequency band may be a different frequency band in a QN band.

The multi-band antenna may include a plurality of antenna elements arranged in a 2×3 form on one surface of the substrate, and antenna elements forming a left 2×2 array among the plurality of antenna elements may perform sequential Rx feeding in a first direction, and antenna elements forming a right 2×2 array among the plurality of antenna elements may perform sequential Tx feeding in a second direction.

According to exemplary embodiments of the present disclosure, a communication node may include a multi-band antenna configured to perform communication with a satellite in a non-terrestrial network in multiple frequency bands. The multi-band antenna may include at least one antenna element disposed on one surface of a substrate. The at least one antenna element may include a first patch; a first port disposed at a first side of the first patch to transmit a signal of a first frequency band to the first patch; a second port disposed at a second side of the first patch perpendicular to the first side of the first patch to transmit a signal of a second frequency band to the first patch; and at least one shorting pin disposed at a position symmetrical to the second port with respect to a y-axis on the first patch.

The multi-band antenna may further include a ground substrate bonded to another surface of the first substrate, and the at least one shorting pin may connect the first patch and the ground substrate.

The at least one shorting pin may include a first shorting pin and a second shorting pin, and the at least one antenna element may adjust an input impedance of the second port by adjusting a spacing between the first shorting pin and the second shorting pin.

The at least one antenna element may adjust an input impedance of the second port by adjusting a distance between the first port and the at least one shorting pin.

The at least one antenna element may further include a coupling slot formed along an outer circumferential surface of the first port, and the first port may transmit the signal of the first frequency band to the first patch through the coupling slot.

The at least one antenna element may further include a second patch disposed adjacent to the first side of the first patch; and a third shorting pin disposed adjacent to a side of the second patch.

The at least one antenna element may adjust isolation between the first port and the second port by adjusting a distance between the side of the second patch and the third shorting pin.

The first frequency band may be a K band, and the second frequency band may be a Ka band. In addition, each of the first frequency band and the second frequency band may be a different frequency band in a QN band.

The multi-band antenna may include a plurality of antenna elements arranged in a 2×3 form on one surface of the substrate, and antenna elements forming a left 2×2 array among the plurality of antenna elements may perform sequential Rx feeding in a first direction, and antenna elements forming a right 2×2 array among the plurality of antenna elements may perform sequential Tx feeding in a second direction.

According to the present disclosure, a multi-band antenna may process transmission and reception of multi-band signals by arranging multiple ports capable of processing signals of different frequency bands on a single radiator. Accordingly, the multi-band antenna may simplify a manufacturing process and may reduce an overall size of the antenna so that a compact design in a limited space may be achieved. In addition, the multi-band antenna may apply different feeding schemes to multiple ports, thereby optimizing polarization or directivity according to frequency characteristics in each of the multiple frequency bands. In addition, the multi-band antenna may arrange a plurality of antenna elements in a 2×3 array structure, thereby reducing complexity of an antenna array or an installation space so that manufacturing costs may be reduced while maintaining high reliability and performance.

### BRIEF DESCRIPTION OF DRAWINGS

FIG. 1 is a conceptual diagram illustrating an exemplary embodiment of a non-terrestrial network.

FIG. 2 is a conceptual diagram illustrating another exemplary embodiment of a non-terrestrial network.

FIG. 3 is a block diagram illustrating an exemplary embodiment of a communication node constituting a non-terrestrial network.

FIG. 4 is a side perspective view of a multi-band antenna according to an exemplary embodiment of the present disclosure.

FIG. 5 is a plan view of the multi-band antenna of FIG. 4.

FIG. 6 is a cross-sectional view taken along line VI-VI′ of the multi-band antenna of FIG. 4.

FIGS. 7A to 7D are graphs illustrating characteristic changes according to operation of the multi-band antenna.

FIGS. 8A to 8D are graphs illustrating radiation patterns of the multi-band antenna.

FIG. 9 is a conceptual diagram illustrating structures of a single-band antenna and a plurality of multi-band antennas.

FIG. 10 is a graph illustrating characteristic changes according to operation of each of the plurality of antennas of FIG. 9.

FIG. 11 is a conceptual diagram illustrating an array antenna including a plurality of multi-band antennas.

FIG. 12 is a graph illustrating characteristic changes according to operation of the array antenna.

FIGS. 13A to 13D are graphs illustrating radiation patterns of the array antenna.

FIG. 14 is a plan view of a multi-band antenna according to another exemplary embodiment of the present disclosure.

FIG. 15 is a graph illustrating characteristic changes according to operation of the multi-band antenna of FIG. 14.

FIGS. 16A to 16D are graphs illustrating radiation patterns of the multi-band antenna of FIG. 14.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system may be a 4G communication system (for example, an LTE (long-term evolution) communication system, an LTE-A communication system), a 5G communication system (for example, an NR (new radio) communication system), a 6G communication system, etc., or the like. The 4G communication system may support communication in a frequency band of 6 GHz or less, and the 5G communication system may support communication not only in a frequency band of 6 GHz or less but also in a frequency band greater than 6 GHz. The communication system to which exemplary embodiments according to the present disclosure are applied is not limited to the contents described below, and exemplary embodiments according to the present disclosure may be applied to various communication systems. Here, the communication system may be used in the same meaning as a communication network, and “LTE” may indicate a “4G communication system,” an “LTE communication system,” or an “LTE-A communication system,” and “NR” may indicate a “5G communication system” or an “NR communication system.”

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

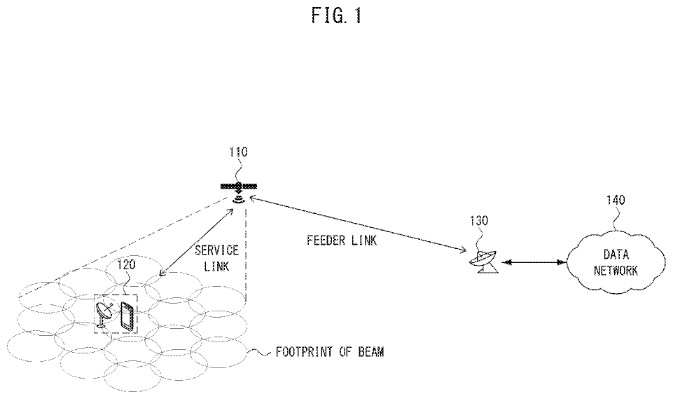

FIG. 1 is a conceptual diagram illustrating an exemplary embodiment of a non-terrestrial network.

As shown in FIG. 1, a non-terrestrial network 100 of the present exemplary embodiment may be a communication network based on at least one satellite 110. The non-terrestrial network 100 may include the satellite 110, a communication node 120, a gateway 130, and a data network 140. The non-terrestrial network 100 of FIG. 1 may be a non-terrestrial network based on a transparent payload.

The satellite 110 may operate as a non-terrestrial base station in the non-terrestrial network. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include communication nodes located on the ground and communication nodes located in a non-terrestrial space. The communication node located on the ground may be a user equipment (UE) or a terminal. The communication node located in the non-terrestrial space may be an airplane or a drone.

A service link may be established between the satellite 110 and the communication node 120. The service link may be a radio link. The satellite 110 may provide communication services to the communication node 120 by using one or more beams. A footprint of a beam of the satellite 110 may be elliptical. One of the beam footprints of the satellite 110 may have a range of 500 to 1,000 km, and a plurality of communication nodes 120 may be located in one beam footprint.

The communication node 120 may perform downlink communication or uplink communication with the satellite 110 using LTE technology and/or NR technology. The communications between the satellite 110 and the communication node 120 may be performed using an NR-Uu interface. When dual connectivity (DC) is supported, the communication node 120 may be connected to other base stations supporting LTE and/or NR functionality as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140.

There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network may be performed based on an NG-C/U interface.

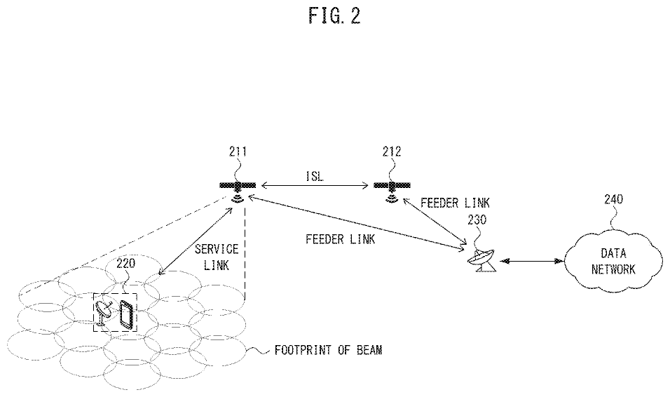

FIG. 2 is a conceptual diagram illustrating another exemplary embodiment of a non-terrestrial network.

As shown in FIG. 2, a non-terrestrial network 200 of the present exemplary embodiment may be a communication network based on a plurality of satellites 211 and 212. The non-terrestrial network 200 may include a first satellite 211, a second satellite 212, a communication node 220, a gateway 230, and a data network 240.

The non-terrestrial network 200 shown in FIG. 2 may be a regenerative payload based NTN. For example, each of the first satellite 211 and the second satellite 212 may perform a regenerative operation on a payload received from other entities (e.g. the communication node 220 or the gateway 230), and transmit the regenerated payload. Here, the regenerative operation may include demodulation, decoding, re-encoding, re-modulation, and/or filtering operations.

Each of the first satellite 211 and the second satellite 212 may be a LEO satellite, a MEO satellite, a GEO satellite, a HEO satellite, or a UAS platform. The UAS platform may include a HAPS. The first satellite 211 may be connected to the second satellite 212, and an inter-satellite link (ISL) may be established between the first satellite 211 and the second satellite 212. The ISL may operate in an RF frequency band or an optical band. The ISL may be established optionally.

The communication node 220 may include a communication node located on the ground and a communication node located in a non-terrestrial space. The communication node located on the ground may be a user equipment (UE) or a terminal. The communication node located in the non-terrestrial space may be an airplane or a drone.

A service link may be established between the first satellite 211 and the communication node 220. The service link may be a radio link. The first satellite 211 may provide communication services to the communication node 220 using one or more beams. A footprint of a beam of the first satellite 211 may be elliptical.

The communication node 220 may perform downlink communication or uplink communication with the first satellite 211 using LTE technology and/or NR technology. The communications between the first satellite 211 and the communication node 220 may be performed using an NR-Uu interface. When DC is supported, the communication node 220 may be connected to other base stations supporting LTE and/or NR functionality as well as the first satellite 211, and may perform DC operations based on the techniques defined in the LTE and/or NR specifications.

The gateway 230 may be located on a terrestrial site, a feeder link may be established between the first satellite 211 and the gateway 230, and a feeder link may be established between the second satellite 212 and the gateway 230. The feeder link may be a radio link. When the ISL is not established between the first satellite 211 and the second satellite 212, the feeder link between the first satellite 211 and the gateway 230 may be established mandatorily. The communications between each of the first satellite 211 and the second satellite 212 and the gateway 230 may be performed based on an NR-Uu interface or an SRI.

There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network may be performed based on an NG-C/U interface.

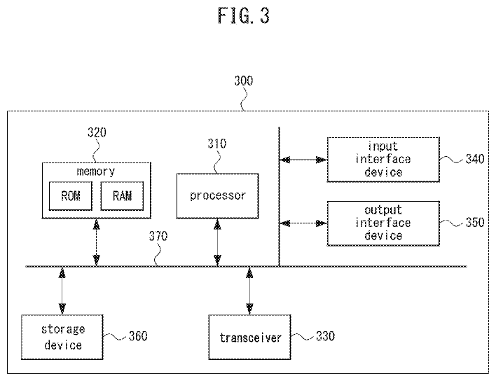

FIG. 3 is a block diagram illustrating an exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed.

Each of the memory 320 and the storage device 360 may be configured as at least one of a volatile storage medium and a nonvolatile storage medium. For example, the memory 320 may be configured with at least one of a read only memory (ROM) and a random access memory (RAM).

In a non-terrestrial network, a satellite may be a low earth orbit satellite, and the low earth orbit satellite may perform communication with a communication node on the ground, for example, a terminal or a gateway, through a multi band. For example, the satellite may perform data communication with the communication node using a K (Kurz) band and/or a Ka (Kurz-above) band. The K band may be a frequency band of 18-26.5 GHz, and the Ka band may be a frequency band of 26.5-40 GHz. Accordingly, the communication node may comprise a multi-band antenna capable of transmitting or receiving a multi-band signal for communication with the satellite. The multi-band antenna may be included in a transmission and reception device of the communication node, but is not limited thereto.

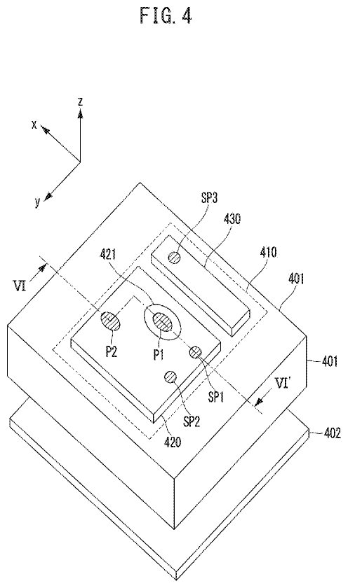

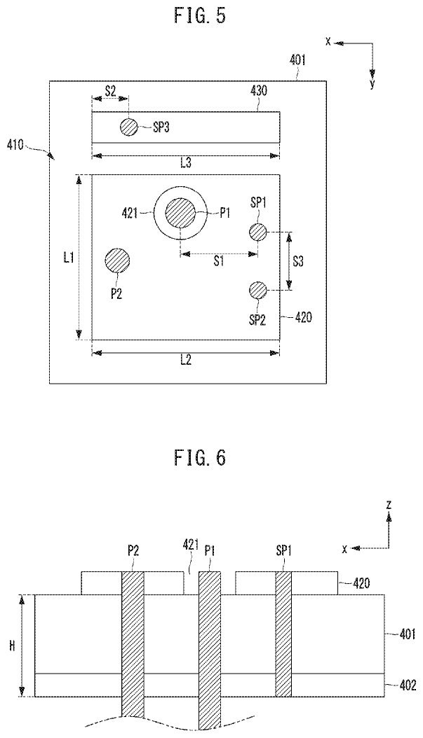

FIG. 4 is a side perspective view of a multi-band antenna according to an exemplary embodiment of the present disclosure. FIG. 5 is a plan view of the multi-band antenna of FIG. 4. FIG. 6 is a cross-sectional view taken along line VI-VI′ of the multi-band antenna of FIG. 4.

As shown in FIGS. 4 to 6, a multi-band antenna 400 according to exemplary embodiments of the present disclosure may include an antenna element 410 capable of transmitting or receiving multi-band signals. A communication node may include transmission or reception beamforming elements capable of processing an RF signal and connected to the antenna element 410.

The multi-band antenna 400 may include a first substrate 401, the antenna element 410, and a second substrate 402. The first substrate 401 and the second substrate 402 may be bonded to each other. The second substrate 402 may be a ground substrate. The antenna element 410 may be disposed on one surface of the first substrate 401. The antenna element 410 may include a first patch 420 and a second patch 430.

The first patch 420 may be a radiator through which transmission or reception of a signal is performed, and the first patch 420 may have a rectangular shape. A horizontal length L2 and a vertical length L1 of the first patch 420 may be identical or may be different from each other.

The antenna element 410 may perform multi-band communication with a satellite. For this purpose, the first patch 420 may include multiple ports connected to different coaxial cables and capable of transmitting and receiving signals in different bands, for example, a first port P1 and a second port P2. The first port P1 may be located at one side of the first patch 420. The second port P2 may be located at another side perpendicular to the one side of the first patch 420. For example, the first port P1 may be located at an upper side of the first patch 420, and the second port P2 may be located at a left side of the first patch 420 in a direction perpendicular to the first port P1.

The first port P1 may include a coupling slot 421. The coupling slot 421 may surround an outer circumferential surface of the first port P1 and may form a predetermined gap. Accordingly, the first port P1 may transmit a signal or energy of a K band applied through a connected coaxial cable to the first patch 420 through the coupling slot 421. The second port P2 may transmit a signal or energy of a Ka band applied through a connected coaxial cable to the first patch 420. The first port P1 may be a coaxial gap feed by the coupling slot 421, and the second port P2 may be a coaxial feed.

The first patch 420 may include a plurality of short pins, for example, a first shorting pin SP1 and a second shorting pin SP2. Each of the first shorting pin SP1 and the second shorting pin SP2 may be located in a direction symmetrical to the second port P2 with respect to a y-axis on the first patch 420. For example, each of the first shorting pin SP1 and the second shorting pin SP2 may be located at a right side of the first patch 420.

Each of the first shorting pin SP1 and the second shorting pin SP2 may connect the first patch 420 and the second substrate 402, that is, the ground substrate. Each of the first shorting pin SP1 and the second shorting pin SP2 may match an input impedance of the coaxial feed of the second port P2, and according to the input impedance matching, the second port P2 may transmit a signal of the Ka band to the first patch 420.

Each of the first shorting pin SP1 and the second shorting pin SP2 may adjust a spacing S3 between the first shorting pin SP1 and the second shorting pin SP2 or may adjust a size of each of the first shorting pin SP1 and the second shorting pin SP2, or may adjust a distance S1 between the first port P1 and the first shorting pin SP1 or the second shorting pin SP2. The second port P2 may be matched by adjusting the input impedance through adjustment of the spacing S3, a size, or the distance S1 of the first shorting pin SP1 and the second shorting pin SP2, and the second port P2 may resonate in the Ka band based on the matched impedance and may transmit a signal of the Ka band to the first patch 420. For example, the first shorting pin SP1 and the second shorting pin SP2 may match the input impedance of the second port P2 in the Ka band by adjusting the spacing S3 between the first shorting pin SP1 and the second shorting pin SP2 or the distance S1 from the first port P1 as shown in Table 1 below.

TABLE 1

| S1 | S3 |
|---|---|
| 0.15 mm | 0.08 mm |

The second patch 430 may be disposed spaced apart from one end of the first patch 420, for example, an upper portion of the first patch 420, by a predetermined distance. A horizontal length L3 of the second patch 430 may be substantially identical to the horizontal length L2 of the first patch 420.

The second patch 430 may include a third shorting pin SP3 disposed adjacent to one side of the second patch 430. The third shorting pin SP3 may connect the second patch 430 and the second substrate 402. The second patch 430 and the third shorting pin SP3 may isolate the first port P1 and the second port P2 of the first patch 420 and may prevent signal interference between the first port P1 and the second port P2. The third shorting pin SP3 may increase isolation between the first port P1 and the second port P2 by adjusting a coupling position with the second patch 430. For example, as shown in Table 2 below, a distance S2 between the third shorting pin SP3 and one side of the second patch 430 may be adjusted, and isolation between the first port P1 and the second port P2 may be increased.

TABLE 2
S2
0.02 mm

As described above, the multi-band antenna 400 of the present disclosure may include the antenna element 410 composed of the first patch 420 and the second patch 430. The first patch 420 may include the first port P1 and the second port P2 for multi-band communication with a satellite in a non-terrestrial network. The first port P1 may include the coupling slot 421, and the first port P1 may transmit a signal of the K band to the first patch 420 by the coupling slot 421. The second port P2 may transmit a signal of the Ka band to the first patch 420. The first patch 420 may further include the first shorting pin SP1 and the second shorting pin SP2 for input impedance matching of the second port P2. The second patch 430 may be disposed spaced apart from the first patch 420 by a predetermined distance and may isolate the first port P1 and the second port P2 by coupling with the third shorting pin SP3.

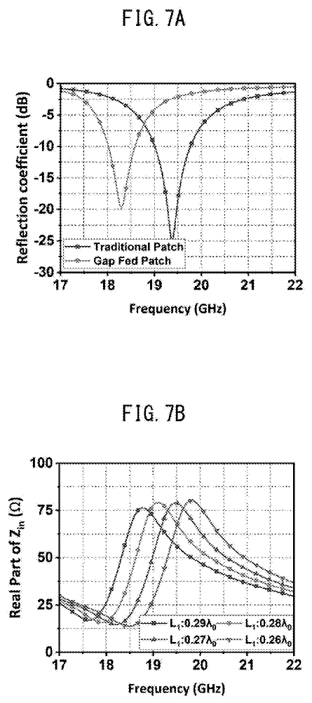

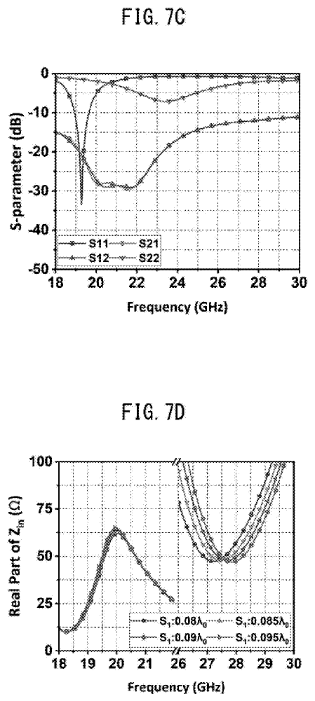

FIGS. 7A to 7D are graphs illustrating characteristic changes according to operation of the multi-band antenna.

As shown in FIG. 7A, as described above, the multi-band antenna 400 of the present disclosure may form the coupling slot 421 in the first patch 420, that is, the radiator, and may form a gap with the first port P1. Accordingly, as shown in FIG. 7A, the multi-band antenna 400 of the present disclosure may reduce a magnitude of a reflection coefficient in the K band compared with a conventional antenna, and reflection loss in the K band may be reduced due to the reduced reflection coefficient.

As shown in FIG. 7B, the multi-band antenna 400 of the present disclosure may form the coupling slot 421 in the first patch 420 and may form a gap with the first port P1. The gap of the first port P1 may generate a series capacitive component, and the series capacitive component may change an input impedance, for example, an input reactance, so that the input impedance may be matched in a relatively high frequency band. Accordingly, as shown in FIG. 7B, even if a size of the first patch 420, for example, the vertical length L1, is reduced, the multi-band antenna 400 of the present disclosure may have a resonance frequency in a high frequency band due to a capacitive element generated by the gap of the first port P1, and therefore an overall size may be reduced compared with the conventional antenna.

As shown in FIG. 7C, the multi-band antenna 400 of the present disclosure may include the first port P1 disposed at the upper side of the first patch 420 and the second port P2 disposed at the left side of the first patch 420. The first port P1 and the second port P2 may be disposed in directions perpendicular to each other. Accordingly, as shown in FIG. 7C, the first port P1 may resonate in a first frequency band, for example, the K band, and the second port P2 may resonate in a second frequency band having a relatively higher frequency than the first frequency band, for example, the Ka band.

As shown in FIG. 7D, the multi-band antenna 400 of the present disclosure may include the first shorting pin SP1 and the second shorting pin SP2, and each of the first shorting pin SP1 and the second shorting pin SP2 may be disposed in a direction symmetrical to the second port P2 with respect to a y-axis in the first patch 420. The first shorting pin SP1 and the second shorting pin SP2 may generate parallel inductance with respect to the first patch 420. The first shorting pin SP1 or the second shorting pin SP2 may adjust and match an input impedance for the second port P2 by adjusting the distance S1 from the first port P1. Accordingly, as shown in FIG. 7D, the second port P2 may resonate at a higher frequency in the Ka band based on the adjusted input impedance.

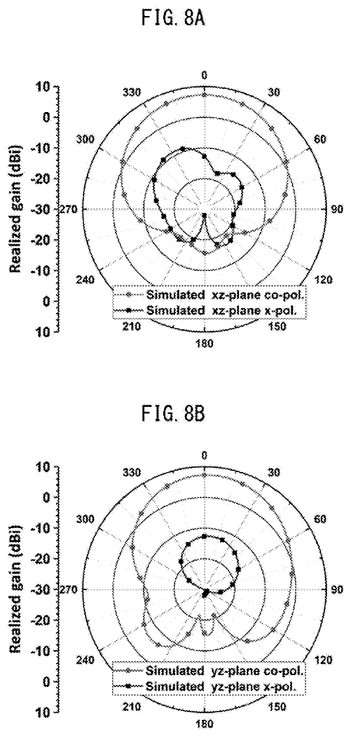

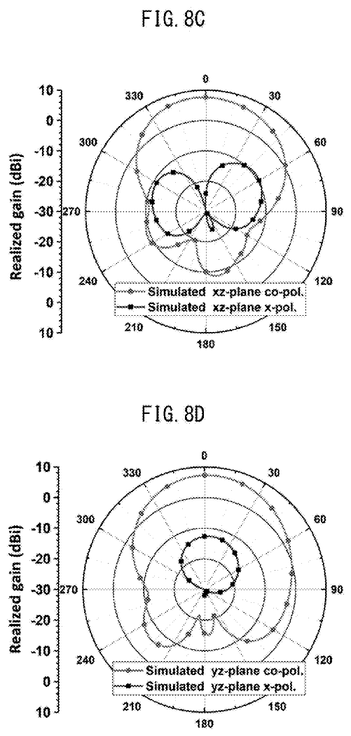

FIGS. 8A to 8D are graphs illustrating radiation patterns of the multi-band antenna. FIG. 8A and FIG. 8B may be graphs illustrating radiation patterns with respect to center frequencies of the first port P1 and the second port P2, respectively, in the K band, and FIG. 8C and FIG. 8D may be graphs illustrating radiation patterns with respect to center frequencies of the first port P1 and the second port P2, respectively, in the Ka band.

As shown in FIG. 8A, the first port P1 of the multi-band antenna 400 may have a radiation pattern having a maximum gain of 7.2 dBi and a cross polarization discrimination (XPD) of 16.2 dB with respect to a first center frequency, for example, 19 GHz, in an xz-plane. As shown in FIG. 8B, the second port P2 of the multi-band antenna 400 may have a radiation pattern having a maximum gain of 7.2 dBi and an XPD of 19.2 dB with respect to the first center frequency in a yz-plane. As shown in FIG. 8C, the first port P1 of the multi-band antenna 400 may have a radiation pattern having a maximum gain of 7.5 dBi and an XPD of 17.5 dB with respect to a second center frequency, for example, 28 GHz, in the xz-plane. As shown in FIG. 8D, the second port P2 of the multi-band antenna 400 may have a radiation pattern having a maximum gain of 7.5 dBi and an XPD of 14.5 dB with respect to the second center frequency in the yz-plane. As described with reference to FIGS. 8A to 8D, the multi-band antenna 400 of the present disclosure may have improved directivity efficiency in a z-axis direction in both the K band and the Ka band and may have a stable XPD value.

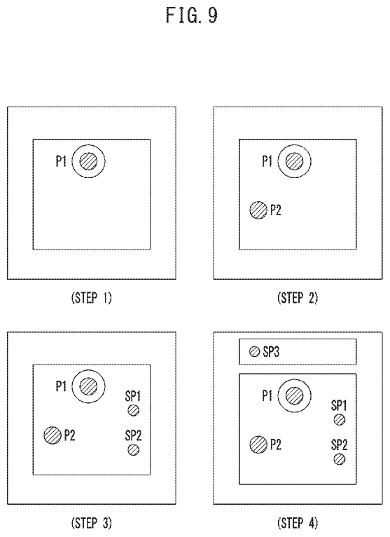

FIG. 9 is a conceptual diagram illustrating structures of a single-band antenna and a plurality of multi-band antennas.

Step 1 of FIG. 9 may be a single-band antenna, and each of step 2, step 3, and step 4 of FIG. 9 may be a multi-band antenna. For example, the antenna of step 1 may include the first port P1. The antenna of step 1 may transmit a signal of a single band, for example, a K band, to a radiator, for example, a patch, through the first port P1. The antenna of step 2 may include the first port P1 and the second port P2 located in a direction perpendicular to the first port P1. In addition, the antenna of step 2 may include a coupling slot formed along an outer circumferential surface of the first port P1. The antenna of step 2 may transmit a signal of the K band to the radiator through the first port P1, and may transmit a signal of the Ka band to the radiator through the second port P2. The antenna of step 3 may include the first port P1 including a coupling slot, the second port P2 located in a direction perpendicular to the first port P1, and the first shorting pin SP1 and the second shorting pin SP2 located in a direction symmetrical to the second port P2 with respect to a y-axis. The antenna of step 3 may transmit a signal of the K band to the radiator through the first port P1, and may transmit a signal of the Ka band to the radiator through the second port P2. Each of the first shorting pin SP1 and the second shorting pin SP2 may move a resonance point of the second port P2 to a higher frequency band in the Ka band. Each of the first shorting pin SP1 and the second shorting pin SP2 may match an input impedance of the second port P2 in the Ka band through adjustment of a spacing therebetween or a distance from the first port P1. The antenna of step 4 may include the first patch and the second patch. The first patch may include the first port P1 including a coupling slot, the second port P2 located in a direction perpendicular to the first port P1, and the first shorting pin SP1 and the second shorting pin SP2 located in a direction symmetrical to the second port P2 with respect to a y-axis. The second patch may be disposed spaced apart from an upper end of the first patch by a predetermined distance and may include the third shorting pin SP3. The antenna of step 4 may transmit a signal of the K band to a radiator, for example, the first patch, through the first port P1, and may transmit a signal of the Ka band to the patch through the second port P2. Each of the first shorting pin SP1 and the second shorting pin SP2 may match an input impedance of the second port P2 in the Ka band through adjustment of a spacing therebetween or a distance from the first port P1. The second patch and the third shorting pin SP3 may isolate the first port P1 and the second port P2 and may prevent signal interference between the first port P1 and the second port P2.

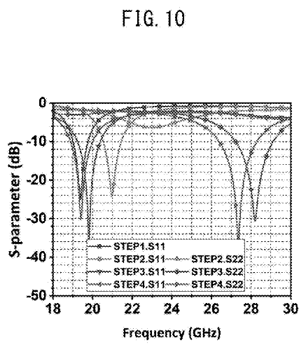

FIG. 10 is a graph illustrating characteristic changes according to operation of each of the plurality of antennas of FIG. 9.

As shown in FIG. 9 and FIG. 10, each of the antennas of step 1 to step 4 may resonate in the K band, and input impedance matching may be achieved at a resonance point of −10 dB or less in the K band.

Since each of the antennas of step 2 to step 4 is a multi-band antenna, each of the antennas of step 2 to step 4 may resonate in the Ka band in addition to the K band described above. Here, the antenna of step 2 may not have an input impedance matched in the Ka band, and accordingly resonance in the Ka band may not be possible. However, in each of the antennas of step 3 and step 4, an input impedance of the second port P2 in the Ka band may be matched by a plurality of shorting pins, for example, the first shorting pin SP1 and the second shorting pin SP2, and therefore each of the antennas of step 3 and step 4 may resonate in the Ka band.

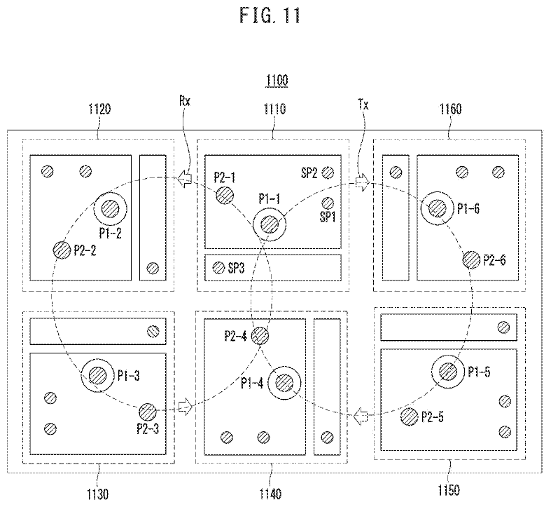

FIG. 11 is a conceptual diagram illustrating an array antenna including a plurality of multi-band antennas.

As shown in FIG. 11, the array antenna 1100 of the present disclosure may include a plurality of antenna elements 1110, 1120, 1130, 1140, 1150, and 1160. The plurality of antenna elements 1110, 1120, 1130, 1140, 1150, and 1160 may be arranged in a 2×3 form and may have a sequential Rx or Tx feeding structure.

Each of the plurality of antenna elements 1110, 1120, 1130, 1140, 1150, and 1160 may include the first patch and the second patch. The first patch may be a radiator through which transmission and reception of a signal are performed and may include the first port P1 and the second port P2 disposed in directions perpendicular to each other. The first port P1 may include a coupling slot. The first port P1 may transmit a signal of the K band to the first patch through the coupling slot, and the second port P2 may transmit a signal of the Ka band to the first patch. The first patch may include the first shorting pin SP1 and the second shorting pin SP2 disposed in a direction symmetrical to the second port P2 with respect to a y-axis. The first shorting pin SP1 and the second shorting pin SP2 may match an input impedance of the second port P2 through adjustment of a spacing therebetween, a size thereof, or a distance from the first port P1. The second patch may be disposed adjacent to one side of the first patch by a predetermined distance and may include the third shorting pin SP3. The second patch and the third shorting pin SP3 may isolate between the first port P1 and the second port P2 and may prevent occurrence of signal interference.

Among the plurality of antenna elements 1110, 1120, 1130, 1140, 1150, and 1160 of the array antenna 1100, antenna elements 1110, 1120, 1130, and 1140 configuring a left 2×2 array may perform sequential Rx feeding in one direction, for example, a counterclockwise direction, based on a second-1 port P2-1. Among the plurality of antenna elements 1110, 1120, 1130, 1140, 1150, and 1160, antenna elements 1110, 1140, 1150, and 1160 configuring a right 2×2 array may perform sequential Tx feeding in one direction, for example, a clockwise direction, based on a first-1 port P1-1.

For example, the antenna elements 1110, 1120, 1130, and 1140 configuring the left 2×2 array may perform sequential Rx feeding in the Ka band in an order of the second-1 port P2-1, a second-2 port P2-2, a second-3 port P2-3, and a second-4 port P2-4. In addition, the antenna elements 1110, 1140, 1150, and 1160 configuring the right 2×2 array may perform sequential Tx feeding in the K band in an order of the first-1 port P1-1, a first-6 port P1-6, a first-5 port P1-5, and a first-4 port P1-4.

According to exemplary embodiments, among the plurality of antenna elements 1110, 1120, 1130, 1140, 1150, and 1160 of the array antenna 1100, the antenna elements 1110, 1120, 1130, and 1140 configuring the left 2×2 array may perform sequential Rx feeding in a clockwise direction based on the second-1 port P2-1, and the antenna elements 1110, 1140, 1150, and 1160 configuring the right 2×2 array may perform sequential Tx feeding in a counterclockwise direction based on the first-1 port P1-1.

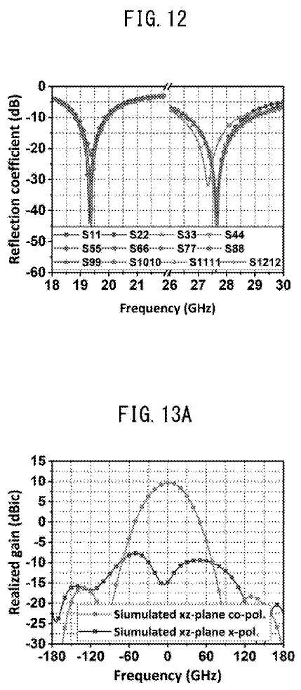

FIG. 12 is a graph illustrating characteristic changes according to operation of the array antenna.

As shown in FIG. 12, the array antenna 1100 may include a plurality of antenna elements 1110, 1120, 1130, 1140, 1150, and 1160, and each of the plurality of antenna elements 1110, 1120, 1130, 1140, 1150, and 1160 may include the first port P1 and the second port P2 capable of operating in each of the K band and the Ka band.

The first port P1 of each of the plurality of antenna elements 1110, 1120, 1130, 1140, 1150, and 1160 may have an impedance bandwidth of 18.8-20 GHz in the K band and may have a minimum isolation of approximately 13.4 dB. The second port P2 of each of the plurality of antenna elements 1110, 1120, 1130, 1140, 1150, and 1160 may have an impedance bandwidth of 26.6-29 GHz in the K band and may have a minimum isolation of approximately 14 dB.

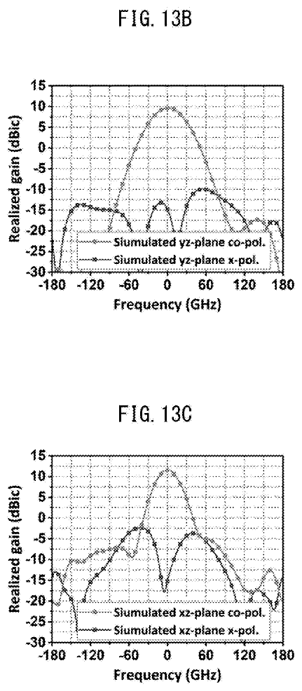

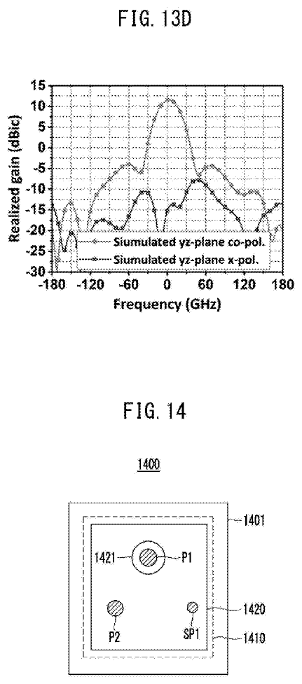

FIGS. 13A to 13D are graphs illustrating radiation patterns of the array antenna. FIG. 13A and FIG. 13B may be graphs illustrating radiation patterns with respect to a center frequency of the array antenna 1100 in the K band, and FIG. 13C and FIG. 13D may be graphs illustrating radiation patterns with respect to a center frequency of the array antenna 1100 in the Ka band.

As shown in FIG. 13A, the array antenna 1100 may have a radiation pattern having a maximum gain of 7.2 dBic and a cross polarization discrimination (XPD) of 16.6 dB with respect to a first center frequency, for example, 19.5 GHz, in an xz-plane. As shown in FIG. 13B, the array antenna 1100 may have a radiation pattern having a maximum gain of 9.6 dBic and an XPD of 19.6 dB with respect to the first center frequency in a yz-plane. As shown in FIG. 13C, the array antenna 1100 may have a radiation pattern having a maximum gain of 11.5 dBic and an XPD of 15.2 dB with respect to a second center frequency, for example, 28 GHz, in the xz-plane. As shown in FIG. 13D, the array antenna 1100 may have a radiation pattern having a maximum gain of 11.5 dBi and an XPD of 19.5 dB with respect to the second center frequency in the yz-plane. As described with reference to FIGS. 13A to 13D, the array antenna 1100 of the present disclosure may have improved directivity efficiency in a z-axis direction in both the K band and the Ka band and may have a stable XPD value. In addition, the array antenna 1100 may have a structure in which the plurality of antenna elements 1110, 1120, 1130, 1140, 1150, and 1160 are arranged in a 2×3 form, and the structure may replace a 2×4 array form of a conventional array antenna, thereby reducing an overall size of the antenna.

FIG. 14 is a plan view of a multi-band antenna according to another exemplary embodiment of the present disclosure.

As shown in FIG. 14, the multi-band antenna 1400 of the present disclosure may include a first substrate 1401 and an antenna element 1410 disposed on one surface of the first substrate 1401. In addition, although not disclosed in the drawings, a second substrate, for example, a ground substrate, may be disposed on another surface of the first substrate 1401.

The multi-band antenna 1400 of the present disclosure may communicate with a satellite in at least two different frequency bands in a QN band, for example, a frequency band of 33-75 GHz. For example, the multi-band antenna 1400 may communicate with the satellite in each of an approximately 39 GHz frequency band and/or a 48 GHz frequency band. Accordingly, the first substrate 1401 of the multi-band antenna 1400 may be a low temperature co-fired ceramic (LTCC) substrate in order to reduce signal loss in the QN band, and a dielectric constant of the first substrate 1401 may be approximately 5.9.

The antenna element 1410 of the multi-band antenna 1400 may include a patch 1420, the first port P1, the second port P2, and at least one shorting pin SP1. The patch 1420 may be a radiator through which a multi-band signal may be transmitted or received, and the patch 1420 may have a rectangular shape. A horizontal length and a vertical length of the patch 1420 may be identical or may be different from each other.

The first port P1 may be located at one side of the patch 1420, for example, an upper side of the patch 1420, and the second port P2 may be located at a position perpendicular to the first port P1, for example, a left side of the patch 1420. The first port P1 may include a coupling slot 1421, and the coupling slot 1421 may surround an outer circumferential surface of the first port P1 and may form a predetermined gap.

The at least one shorting pin SP1 may be located in a direction symmetrical to the second port P2 with respect to a y-axis, for example, a right side of the patch 1420. The shorting pin SP1 may connect the patch 1420 and the second substrate. The shorting pin SP1 may finely adjust and match an input impedance of the second port P2 according to adjustment of a spacing from the first port P1.

The first port P1 of the multi-band antenna 1400 may transmit one QN band signal applied through a coaxial cable, for example, a signal of a 39 GHz frequency band, to the patch 1420 through the coupling slot 1421. The second port P2 may transmit another QN band signal applied through a coaxial cable, for example, a signal of a 48 GHz frequency band, to the patch 1420. The at least one shorting pin SP1 may match an input impedance of a QN band coaxial feed of the second port P2.

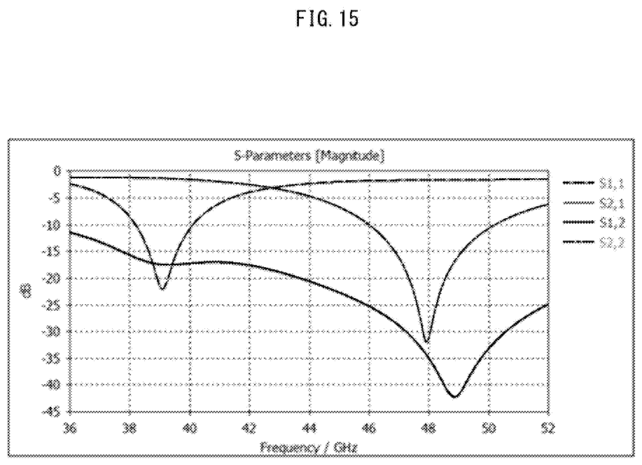

FIG. 15 is a graph illustrating characteristic changes according to operation of the multi-band antenna of FIG. 14.

As shown in FIG. 15, the multi-band antenna 1400 of the present disclosure may have an operating frequency of 38.1-40.1 GHz of the first port P1 and an operating frequency of 46-50.2 GHz of the second port P2. Isolation between the first port P1 and the second port P2 may have a minimum of −16.2 dB within an operating frequency range of the first port P1.

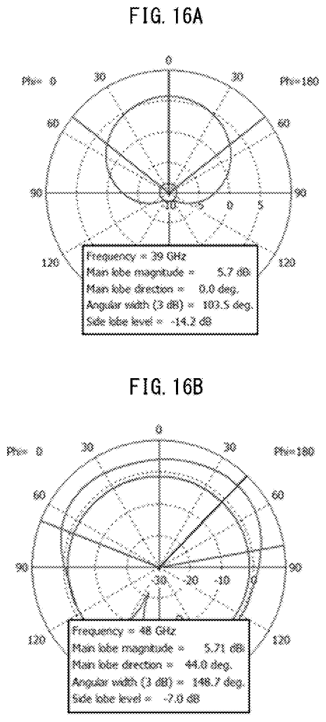

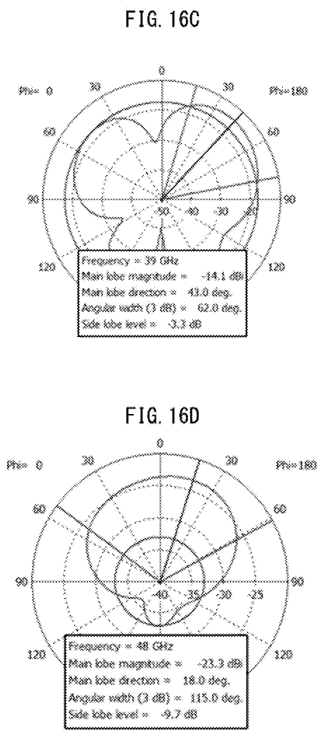

FIGS. 16A to 16D are graphs illustrating radiation patterns of the multi-band antenna of FIG. 14. Each of FIG. 16A and FIG. 16B may be a graph illustrating a radiation pattern for co polarization in the QN band, and each of FIG. 16C and FIG. 16D may be a graph illustrating a radiation pattern for cross polarization in the QN band.

As shown in FIG. 16A, the first port P1 of the multi-band antenna 1400 may have a radiation pattern having a maximum gain of 5.7 dBi for co polarization at a first center frequency, for example, an approximately 39 GHz frequency. As shown in FIG. 16B, the second port P2 of the multi-band antenna 1400 may have a radiation pattern having a maximum gain of 5.7 dBi for co polarization at a second center frequency, for example, a 48 GHz frequency.

As shown in FIG. 16C, the first port P1 of the multi-band antenna 1400 may have a radiation pattern having a maximum gain of −14.1 dBi for cross polarization at the first center frequency. As shown in FIG. 16D, the second port P2 of the multi-band antenna 1400 may have a radiation pattern having a maximum gain of −22.3 dBi for cross polarization at the second center frequency.

Operation of a method according to an exemplary embodiment of the present disclosure may be implemented as a program or code readable by a computer in a computer-readable recording medium. The computer-readable recording medium includes all kinds of recording devices in which information readable by a computer system is stored. In addition, the computer-readable recording medium may be distributed in computer systems connected through a network, and a computer-readable program or code may be stored and executed in a distributed manner.

In addition, the computer-readable recording medium may include hardware devices specially configured to store and execute program commands, such as ROM, RAM, flash memory, etc., or the like. The program commands include not only machine language code created by a compiler, but also high-level language code executable by a computer using an interpreter, etc., or the like.

Although some aspects of the present disclosure have been described in the context of an apparatus, the some aspects may also represent a description according to a corresponding method, in which a block or the apparatus corresponds to a method operation or a feature of the method operation. Similarly, aspects described in the context of a method may also be represented as features of a corresponding block or item, or a corresponding apparatus. Some or all of method operations may be performed by or using a hardware device, for example, a microprocessor, a programmable computer, or an electronic circuit. In some exemplary embodiments, at least one or more of the most important method operations may be performed by such a device.

In exemplary embodiments, a programmable logic device, for example, a field programmable gate array, may be used to perform some or all of functions of methods described herein. In exemplary embodiments, the field programmable gate array may operate together with a microprocessor in order to perform one of methods described herein. Generally, the methods are preferably performed by any hardware device.

Although the present disclosure has been described above with reference to preferred exemplary embodiments of the present disclosure, a person skilled in the art will understand that the present disclosure may be variously modified and changed without departing from the spirit and region of the present disclosure set forth in the claims below.

What is claimed is:

1. A multi-band antenna, comprising:
at least one antenna element disposed on one surface of a substrate,
wherein the at least one antenna element comprises:
a first patch;
a first port disposed at a first side of the first patch to transmit a signal of a first frequency band to the first patch;
a second port disposed at a second side of the first patch perpendicular to the first side of the first patch to transmit a signal of a second frequency band to the first patch; and
at least one shorting pin disposed at a position symmetrical to the second port with respect to a y-axis on the first patch.

2. The multi-band antenna of claim 1, further comprising a ground substrate bonded to another surface of the first substrate,
wherein the at least one shorting pin connects the first patch and the ground substrate.

3. The multi-band antenna of claim 1, wherein the at least one shorting pin comprises a first shorting pin and a second shorting pin, and
wherein the at least one antenna element adjusts an input impedance of the second port by adjusting a spacing between the first shorting pin and the second shorting pin.

4. The multi-band antenna of claim 1, wherein the at least one antenna element adjusts an input impedance of the second port by adjusting a distance between the first port and the at least one shorting pin.

5. The multi-band antenna of claim 1, wherein the at least one antenna element further comprises a coupling slot formed along an outer circumferential surface of the first port, and
wherein the first port transmits the signal of the first frequency band to the first patch through the coupling slot.

6. The multi-band antenna of claim 1, wherein the at least one antenna element further comprises:
a second patch disposed adjacent to the first side of the first patch; and
a third shorting pin disposed adjacent to a side of the second patch.

7. The multi-band antenna of claim 6, wherein the at least one antenna element adjusts isolation between the first port and the second port by adjusting a distance between the side of the second patch and the third shorting pin.

8. The multi-band antenna of claim 1, wherein the first frequency band is a K band, and the second frequency band is a Ka band.

9. The multi-band antenna of claim 1, wherein each of the first frequency band and the second frequency band is a different frequency band in a QN band.

10. The multi-band antenna of claim 1, wherein the multi-band antenna comprises a plurality of antenna elements arranged in a 2×3 form on a surface of the substrate,
wherein antenna elements forming a left 2×2 array among the plurality of antenna elements perform sequential Tx feeding in a first direction, and
wherein antenna elements forming a right 2×2 array among the plurality of antenna elements perform sequential Rx feeding in a second direction.

11. A communication node comprising:
a multi-band antenna configured to perform communication with a satellite in a non-terrestrial network in multiple frequency bands,
wherein the multi-band antenna comprises at least one antenna element disposed on one surface of a substrate,
wherein the at least one antenna element comprises:
a first patch;
a first port disposed at a first side of the first patch to transmit a signal of a first frequency band to the first patch;
a second port disposed at a second side of the first patch perpendicular to the first side of the first patch to transmit a signal of a second frequency band to the first patch; and
at least one shorting pin disposed at a position symmetrical to the second port with respect to a y-axis on the first patch.

12. The communication node of claim 11, wherein the multi-band antenna further comprises a ground substrate bonded to another surface of the first substrate,
wherein the at least one shorting pin connects the first patch and the ground substrate.

13. The communication node of claim 11, wherein the at least one shorting pin comprises a first shorting pin and a second shorting pin, and
wherein the at least one antenna element adjusts an input impedance of the second port by adjusting a spacing between the first shorting pin and the second shorting pin.

14. The communication node of claim 11, wherein the at least one antenna element adjusts an input impedance of the second port by adjusting a distance between the first port and the at least one shorting pin.

15. The communication node of claim 11, wherein the at least one antenna element further comprises a coupling slot formed along an outer circumferential surface of the first port, and
wherein the first port transmits the signal of the first frequency band to the first patch through the coupling slot.

16. The communication node of claim 11, wherein the at least one antenna element further comprises:
a second patch disposed adjacent to the first side of the first patch; and
a third shorting pin disposed adjacent to a side of the second patch.

17. The communication node of claim 16, wherein the at least one antenna element adjusts isolation between the first port and the second port by adjusting a distance between the side of the second patch and the third shorting pin.

18. The communication node of claim 11, wherein the first frequency band is a K band, and the second frequency band is a Ka band.

19. The communication node of claim 11, wherein each of the first frequency band and the second frequency band is a different frequency band in a Q/V band.

20. The communication node of claim 11, wherein the multi-band antenna comprises a plurality of antenna elements arranged in a 2×3 form on a surface of the substrate,
wherein antenna elements forming a left 2×2 array among the plurality of antenna elements perform sequential Tx feeding in a first direction, and
wherein antenna elements forming a right 2×2 array among the plurality of antenna elements perform sequential Rx feeding in a second direction.
